(19) United States
(12) Patent Application Publication
(10) Pub. No.: US 2012/0116621 A1
(43) Pub. Date: May 10, 2012

(54) WHEEL HAVING ELECTRIC DRIVE MEANS

(76) Inventor: Chi Jae So, Gyeonggi-do (KR)

(21) Appl. No.: 13/126,285

(22) PCT Filed: Jun. 25, 2010
(86) PCT No.: PCT/KR2010/004141

§ 371 Date: Apr. 27, 2011

(30) Foreign Application Priority Data
Sep. 4, 2009 (KR) 10-2009-0083340

(51) Int. Cl. B60K 7/00

(52) U.S. Cl. 701/22

(57) ABSTRACT

A wheel equipped with an electrical drive unit is provided. The wheel includes a stator having a plurality or windings about a central fixing shaft, a rotor surrounding the stator while being spaced apart from the stator and having a plurality of magnets, a rim having a cylindrical shape, receiving the rotor and the stator therein, a plurality of air guide protrusions formed in a circumference direction on outer and inner plates of the rim, a wheel speed sensor mounted on the stator, a tire pressure sensor measuring an air pressure of the tire, and a controller receiving sensor input values of a wheel through an operation section and receives geographic and road information through a GPS receiver. The steering and braking performance of the wheel equipped with the electrical drive unit are improved, so that the whole driving performance of the wheel is improved.

### BACKGROUND OF THE INVENTION

1. Field of the Invention

The present invention relates to a wheel equipped with an electrical drive unit. More particularly, the present invention relates to an eco-friendly wheel equipped with an electrical drive unit, capable of saving energy by preventing the energy from being unnecessarily wasted by a power transmission apparatus.

2. Description of the Related Art

In general, a vehicle is driven by a wheel rotating by torque supplied from one engine. Since the torque generated during fuel combustion is mainly used, environmental pollution may be caused.

In this regard, an electrical vehicle driven through an electrical driving scheme has been suggested and actively developed. According to the electrical driving scheme, a motor is rotated by using a battery mounted in the vehicle as a power supply to drive a wheel.

In addition, a vehicle equipped with an electrical drive unit has been developed, in which a final driving unit of the vehicle is installed inside a wheel to transmit power.

A wheel of Korean Patent Registration No. 10-0753876 includes a rotor, an electrical motor including a stator having windings, a control unit of controlling the output of the electrical motor, a receiving space installed in the wheel to receive the control unit, a measuring unit, an actuating unit connected to the control unit and the measuring unit in order to drive the wheel, a data transmitting unit connected to the actuating unit to transmit data to the outside of the wheel, and a cooling fluid inlet, a cooling fluid outlet, and a cooling fluid circulation space provided in the wheel. A cooling fluid is supplied through the cooling fluid inlet, circulates in the cooling fluid circulation space, and is output through the cooling fluid outlet, thereby cooling the windings and the wall of the receiving space during the driving of the wheel. The electrical motor directly drives the wheel. The electrical motor, the control unit, the measuring unit, the actuating unit, and the data transmitting unit are provided in the wheel. The wheel has an outer surface, and the cooling fluid inlet and the cooling fluid outlet pass through the outer surface of the wheel.

According to the wheel of the above patent, the electrical drive unit is installed in the wheel and individually controlled, and a control process unit controls wheels mounted in a vehicle in common. Accordingly, the data transmission is complicated, the internal structure becomes complex, and a braking unit and a cooling unit do not smoothly operate.

### SUMMARY OF THE INVENTION

The present invention provides a wheel equipped with an electrical drive unit, in which at least two wheels are controlled by a controller while receiving battery power, and a braking structure is provided in addition to a brake device.

The present invention provides a wheel equipped with an electrical drive unit having a structure capable of effectively cooling a driving unit and a battery provided inside a rim.

The present invention also provides an eco-friendly wheel equipped with an electrical drive unit having a structure capable of saving energy to be unnecessarily wasted by a power transmission apparatus.

In order to accomplish the above objects, there is provided a wheel equipped with an electrical drive unit. The wheel includes a stator having a plurality of windings about a central fixing shaft, a rotor surrounding the stator while being spaced apart from the stator and having a plurality of magnets to rotate according to intensities of a current flowing through the windings, a rim having a cylindrical shape, receiving the rotor and the stator therein, and provided at an outer peripheral portion thereof a tire, a plurality of air guide protrusions formed in a circumference direction on outer and inner plates of the rim to allow air to be easily introduced, a wheel speed sensor mounted on the stator to count the number of revolution of the rotor, a tire pressure sensor measuring an air pressure of the tire, and a controller receiving sensor input values of a wheel, which are transmitted from a wheel speed sensor and a tire pressure sensor, through an operation section and receives geographic and road information through a GPS receiver to control values of currents being supplied to the stator of each wheel.

According to the present invention, the wheel includes a current controller controlling a rotation speed while changing current values of power being supplied to each stator under a control operation of the controller, and overheat prevention sections transmitting a deceleration signal to the controller so that a speed of the wheel is reduced to prevent a driving unit including the rotor and the battery from being overheated based on a temperature value from a rotor temperature sensor, which is mounted on the rotor to measure a temperature of a wheel during driving of the wheel, and a temperature value of the battery obtained by a battery temperature sensor.

According to the present invention, the wheel includes a current detector measuring remaining power of the battery being supplied to the stator to transmit a measurement result to the controller, and a power generation controller automatically charging and supplying power while driving an alternator by using torque of a small power generator for a vehicle under the control operation of the controller if power of the battery is consumed according to a detection result of the current detector.

According to the present invention, the wheel includes a cooling air supply section cooling the compressed air of a compressor together with air introduced through the air inflow protrusions of the rim by supplying the compressed air to the rotor and the stator under the control operation of the controller if cooling is required based on temperature values from the overheat prevention section.

As described above, according to the present invention, at least two wheels are provided to receive battery power under the control of the controller. Accordingly, dual braking effects can be obtained by controlling the speed of the wheels by using a current being supplied to the stator in addition to a braking device.

In addition, a great amount of air can be introduced through a plurality of air guide protrusions formed in a circumferential direction on the lateral surface and a cover of the rim and cooling can be effectively performed by air through a cooling air supply section.

The controller receives sensor input values of wheels, which are transmitted from the wheel speed sensor and the tire pressure sensor, through an operation section and receives geographic and road information through the GPS receiver to control the values of currents being supplied to a stator of at least one wheel while controlling the driving of the wheel. Accordingly, an eco-friendly wheel can be provided, and energy to be unnecessarily consumed by a power transmission apparatus can be saved.

### BRIEF DESCRIPTION OF THE DRAWINGS

FIG. 1 is an exploded perspective view showing a wheel equipped with an electrical drive unit according to the present invention;

FIG. 2 is a front sectional view showing the coupling state of FIG. 1;

FIG. 3 is a side sectional view showing an electrical drive unit of FIG. 1 according to the present invention;

FIG. 4 is a perspective view showing a slide disk fitted around a rotational shaft provided with a brake rotor according to the present invention; and

FIG. 5 is a flowchart schematically showing the procedure of controlling the operation of a wheel according to the present invention.

### DESCRIPTION OF THE EMBODIMENTS

Hereinafter, exemplary embodiments of the present invention will be described in detail with reference to accompanying drawings. The same reference numerals will be assigned to the same components even if the components are shown in different drawings. In the following description, if detailed description of the components of the related art or functions thereof makes the subject matter of the present invention unclear, the detailed description of the components of the related art or the functions thereof will be omitted.

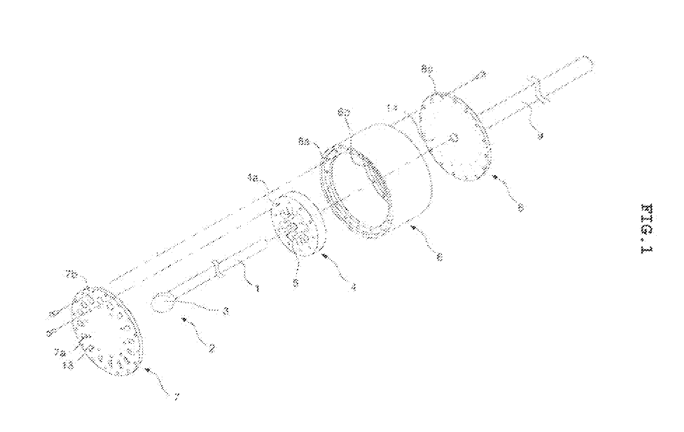

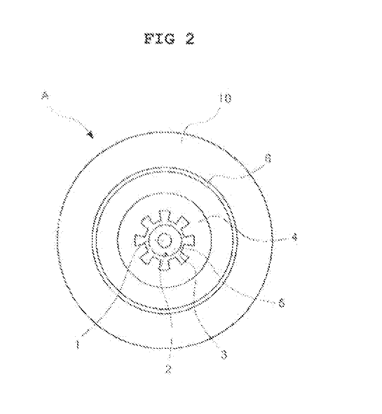

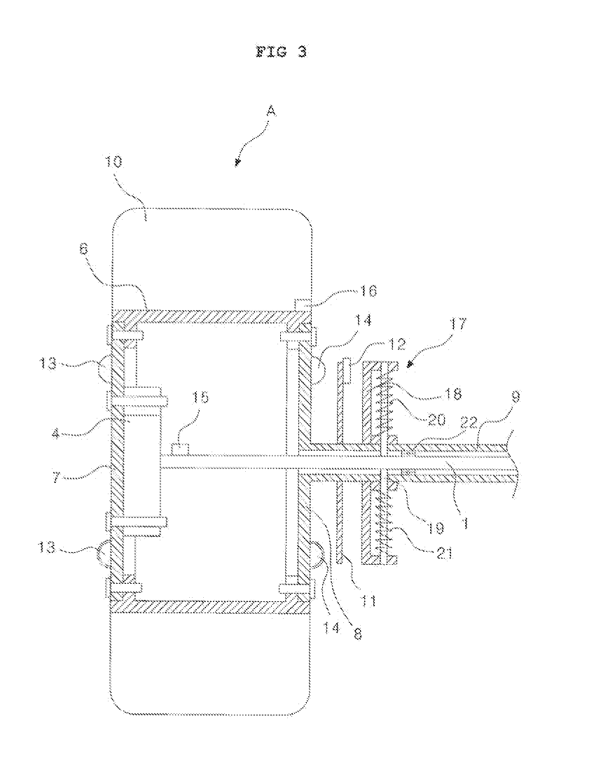

FIG. 1 is an exploded perspective view showing a wheel equipped with an electrical drive unit according to the present invention, and FIG. 2 is a front sectional view showing the coupling state of FIG. 1. FIG. 3 is a side sectional view showing the wheel equipped with the electrical drive unit of FIG. 1 according to the present invention.

The wheel equipped with the electrical drive unit according to the present invention includes a stator 2 having a plurality of windings 3 about a fixing shaft 1 provided at the central portion of the wheel, a rotor 4 surrounding the stator 2 while being spaced apart from the stator 2 and having a plurality of magnets 5, an outer plate 7 coupled with a bolt hole 4a formed in the rotor 4 through a bolt hole 7a, a cylindrical rim 6 coupled with an outer bolt hole 7b of the outer surface 7 through a bolt hole 6a and provided at an outer peripheral portion thereof with a tire 10, and an inner plate 8 provided in opposition to the outer plate 7 about the rim 6 and provided at the central portion thereof with a rotational shaft 9.

A bolt hole 8a of the inner plate 8 is coupled with a bolt hole 6b of the rim 6, so that the inner plate 8 is coupled with the rim 6. A plurality of air guide protrusions 13 and 14 protrude outward from the outer and inner plates 7 and 8 about the rim 6 while being incised in the circumferential direction.

Therefore, if the components are coupled with each other, the stator 2 and the rotor 4 are placed inside the rim 6, and the rotor 4 is coupled with the outer plate 7.

The fixing shaft 1 is partially provided inside a hollow-type rotational shaft 9, and a bearing 22 is interposed between the fixing shaft 1 and the rotational shaft 9 to space the fixing shaft 1 apart from the rotational shaft 9.

A brake rotor 11 is provided on the rotational shaft 9 and braked due to a braking force applied to a brake pad 12 while rotating together with the inner palate 8 in a state that the brake rotor 11 is spaced apart from the inner plate 8.

A brake device including the brake pad 12 is a brake device of a typical vehicle, and the operating procedure of the brake device is identical to the operating procedure of a drum brake or a caliper brake which is the brake device of the typical vehicle.

According to the present invention, differently from the typical vehicle, since a gear shifter is not employed, the engine brake is not operated, so that a brake function is performed by adjusting the intensity of current transmitted to the stator 2.

A wheel speed sensor 15 is mounted on the stator 2 to count the number of the revolution of the rotor 4, and a tire pressure sensor 16 is provided at an outer portion of the rim 6 to measure the air pressure of a tire 10.

A damper 17 is provided on the rotational shaft 9 while being spaced apart from the pad 12 to absorb vertical vibration during the driving of a vehicle. The damper 17 includes a support plate 18 spaced apart from the pad 12 and provided at an outer peripheral portion of the rotational shaft 9, a support shaft 19 mounted on the rotational shaft 9 in adjacent to the support plate 18, and upper and lower springs 20 and 21 fitted around upper and lower ends of the support shaft 19.

The outer peripheral portion of the support plate 18 is coupled with a vehicle body through a bearing, so that the vertical vibration can be attenuated through the tensile force and the compressive force of the upper and lower springs 20 and 21. Accordingly, the vertical vibration can be absorbed during the driving of the vehicle.

The stator 2 is electrically and physically classified into at least two winding groups similarly to the stator 2 used in the typical motor.

The bolt hole 7b of the outer plate 7 and the bolt hole 8a of the inner plate 8 are firmly coupled with bolt holes 6a and 6b formed in outer and inner surfaces of the rim 6 through a bolt coupling scheme, thereby protecting the electrical drive unit of the rotor 4 and the stator 2.

In addition, the bearing 22 is fitted around an outer surface of the fixing shaft 1 of the stator 2 so that the rotational shaft 9 making contact with the outer surface of the fixing shaft 1 can smoothly rotate.

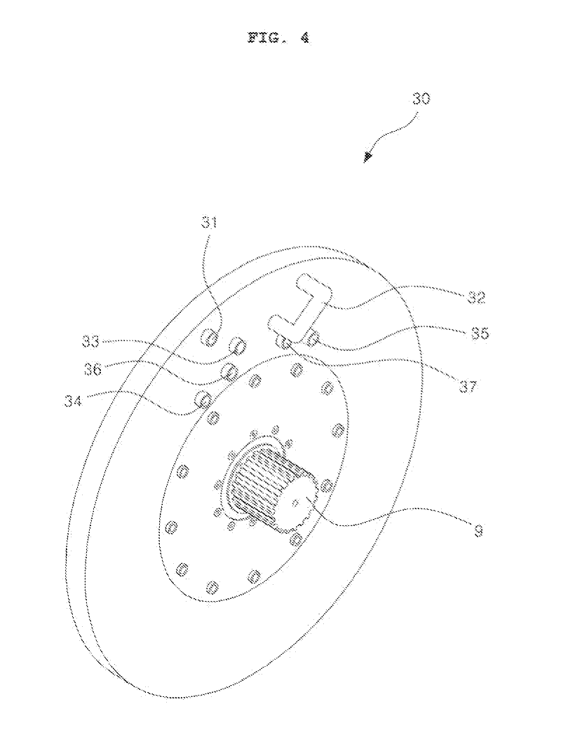

FIG. 4 is a perspective view showing a slide disk 30 fitted around the rotational shaft 9 having the brake rotor 11 according to the present invention.

Cooling water, power, and signals can be supplied through the slide disk 30 rotating about the rotational shaft 9 together with the brake rotor 11. After the cooling water has been supplied from a cooling water container, which is not shown in FIG. 4, to an outer peripheral portion of the slide disk 30 through a cooling water supply line 31 by a pump 55, the cooling water is supplied to an inner peripheral portion of the slide disk 30 through the cooling water connection line 32. Then, the cooling water returns to the cooling water container through a cooling water return line 33.

A control signal transmitted from a controller, which is not shown in FIG. 4, and input information transmitted from the wheel speed sensor 15 and the tire pressure sensor 16 to the controller are mutually transmitted through signal lines 34 and 35.

Power wires are connected to power lines 36 and 37 to supply power to the stator 2.

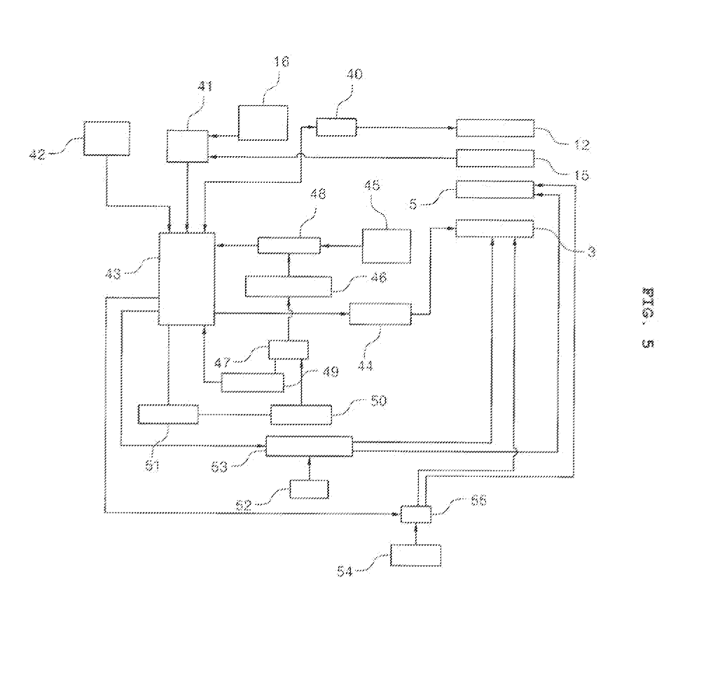

FIG. 5 is a flowchart schematically showing the procedure of controlling the operation of the wheel according to the present invention.

As shown in FIG. 5, an apparatus for controlling the operation of the wheel according to the present invention includes a winding 3 of the stator 2 of generating a rotational magnetic field in a circumferential direction about the fixing shaft 1, which is provided at the central portion of the wheel, by a current applied from an external device, the magnets 5 of the rotor 4 attached to the outer plate 7 of the rim 6 to rotate in such a manner that the magnets 5 are positioned at the outside of the winding 3 of the stator 2, a braking section 40 of operating a brake pad 12, which presses against the brake rotor 11 fitted around the rotational shaft 9, the wheel speed sensor 15 mounted on the lateral surface of the stator 2 to count the number of the revolution of the rotor 4 to calculate the speed of the wheel, the tire pressure sensor 16 of measuring the air pressure of the tire 10 to notify the filling state of air and allow the wheel speed sensor 15 to exactly calculate the speed of the wheel, and a controller 43 of receiving sensor input values of each wheel A, which are transmitted from the wheel speed sensor 15 and the tire pressure sensor 16 through the signal lines 34 and 35, through an operation section 41 and receiving geographic and road information through a GPS receiver 42 to control the values of currents being supplied to the stator 2 of each wheel A through the signal lines 34 and 35 while controlling the driving of the wheel.

The apparatus for controlling the operation of the wheel according to the present invention includes a current controller 44 of controlling the rotation speed while changing the current values of power being supplied to stators 4 through power wires connected to the power line 36 and 37 under the control of the controller 43, overheat prevention sections 48 of transmitting a deceleration signal to the controller 43 so that the speed of the wheel can be reduced to prevent the driving unit including the rotor 4 and the battery from being overheated based on the temperature values from rotor temperature sensors 45, which are mounted on rotors 4 to measure the temperature of the wheel during the driving of the wheel, and the temperature values of the battery 47 obtained by a battery temperature sensor 46, a current detector 49 of measuring the remaining power of the battery 47 being supplied to the stator 2 to transmit the result to the controller 43, and a power generation controller 51 of automatically charging and supplying power while driving an alternator 50 by using the torque of a small power generator for a vehicle under the control of the controller 43 if about 40% of power of the battery 47 is consumed according to the detection result of the current detector 49.

Further, the apparatus for controlling the operation of the wheel according to the present invention includes a cooling air supply section 53 of cooling the compressed air of a compressor 52 together with air introduced through the air guide protrusions 13 and 14 of the rim 6 by supplying the compressed air to the rotor 2 and the stator 4 under the control of the controller 43 if cooling is required based on the temperature values from the overheat prevention section 48, and pumps of allowing cooling water stored in a cooling water container 54 operating under the control of the controller 43 to be supplied to an outer peripheral portion through the cooling water supply line 31, supplied to an inner peripheral portion through the cooling water connection line 32, and then retrieved into the cooling water container 54 through the cooling water return line 33.

In this case, the controller 43 simultaneously and independently controls at least two wheels A mounted on one vehicle, so that the vehicle can be stably driven.

At least two wheels equipped with the electrical drive unit according to the present invention having the structure are installed in one vehicle, so that the wheels can be effectively driven under the control of the controller 43 while stably operating.

The rotor 4 is fixedly coupled with the outer plate 7 of the rim 6 through a bolt, and the stator 2 is positioned inside the rim 6, thereby protecting the electrical drive unit and achieving stable rotation about the rotational shaft 9.

The inner plate 8 integrated with the rotational shaft 9 is detachably coupled with the inner surface of the rim 6 in a state that components including the rotor 4 and the stator 2 are coupled to the inner surface of the rim 6, so that the components including the stator 2 and the rotor 4 can be easily replaced.

In order to move the vehicle, the controller 43 supplies power charged in the battery 47 by the current controller 44 or supplies power current, which is generated from the alternator 50 by using the torque of a small power generator for a vehicle, to the winding 3 of each stator 2, so that the rotational magnetic field is generated in a circumferential direction about the fixing shaft 1 provided at the central portion of the wheel.

The rotor 4 provided at an outer peripheral portion of the wheel due to the magnetic field of the stator 2 and including a plurality of magnets 5 rotates according to the intensity of the current flowing through the winding 3 of the stator 2.

The wheel speed sensor 15 mounted on the lateral surface of the stator 2 counts the number of the revolution of the rotor 4 to calculate the speed of the wheel.

The tire pressure sensor 16 measures the air pressure of the tire 10 so that the filling state of the air of the tire 10 can be notified and the speed of the wheel can be more exactly calculated.

The controller 43, which receives sensor input values of the wheel A obtained from the wheel speed sensor 15 and the tire pressures sensor 16 through the operation section 41, receives geographic information through the GPS receiver 42, to control the values of currents being supplied to the stator 2 of each wheel A through the current controller 44, thereby controlling the stable driving of the wheel A.

The overheat prevention sections 48 reports that a vehicle is over heated by transmitting a deceleration signal to the controller 43 based on the temperature values from rotor temperature sensors 45, which are mounted on the rotors 4 to measure the temperature of the wheel during the driving of the wheel, and the temperature values of the battery 47 obtained by the battery temperature sensor 46, thereby reducing the speed of the vehicle.

In more detail, the deceleration control is performed before the wheel is overheated. Even if a cooling unit is out of order, since a safety temperature to prevent the wheel from being overheated is set, the wheel can be protected before the wheel is overheated by only controlling the speed of the wheel without brake control. For example, the vehicle may be forcibly driven at 50% or less of a normal speed, or at a low speed of 20 KM/H or less, so that a driver can repair the wheel in a garage.

Meanwhile, if cooling is required based on the temperature values from the overheat prevention sections 48, the cooling air supply section 53 controlled by the controller 43 supplies the compressed air of the compressor 52 to the rotor 2 and the stator 4 to rapidly cool the compressed air together with the air introduced through the air guide protrusions 13 and 14 of the rim 6.

Cooling water supplied by the pump from the cooling water container 54 is supplied to the outer peripheral portion through the cooling water supply line 31 to be primarily cooled, supplied to the inner peripheral portion through the cooling water connection line 32 to be secondarily cooled, and then retrieved into the cooling water container 54 through the cooling water return line 33. Accordingly, an air cooling scheme and a water cooling scheme can be simultaneously performed, so that cooling can be smoothly performed.

A control signal, which is transmitted from the controller 43 to the wheel speed sensor 15 and the tire pressure sensor 16 through the current controller 44, is transmitted to the stator 2 through the signal lines 34 and 35. Meanwhile, the input information from the wheel speed sensor 15 and the tire pressure sensor 16 is transmitted to the controller 43 through the signal lines 34 and 35.

The power wires used to supply necessary power to the stator 2 are connected through the power lines 36 and 37, so that signals, power, and cooling water can smoothly flow.

The current detector 49 measures remaining power of the battery 47 to be supplied to the stator 2 to transfer the information about the power to the controller 43. Accordingly, if about 40% of power of the battery 47 is consumed, the alternator 50 is driven by using the torque of the small power generator for a vehicle under the control of the controller, so that power charging and power supplying can be automatically achieved.

As described above, at least two wheels equipped with the electrical drive unit according to the present invention are provided to receive battery power under the control of the controller. Accordingly, dual braking effects can be obtained by controlling the speed of the wheels by using a current being supplied to the stator in addition to the braking device.

In addition, a great amount of air can be introduced through a plurality of air guide protrusions formed in a circumferential direction on the lateral surface and a cover of the rim 6 and cooling can be effectively performed through a cooling air supply section.

The controller receives sensor input values of a wheel A, which are transmitted from the wheel speed sensor and the tire pressure sensor, through an operation section and receives geographic and road information through the GPS receiver to control the values of currents being supplied to a stator of at least one wheel while controlling the driving of the wheel. Accordingly, an eco-friendly wheel can be provided, and energy to be unnecessarily consumed by a power transmission apparatus can be saved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A wheel equipped with an electrical drive unit, the wheel comprising:
a stator having a plurality of windings about a central fixing shaft;
a rotor surrounding the stator while being spaced apart from the stator and having a plurality of magnets to rotate according to intensities of a current flowing through the windings:
a rim having a cylindrical shape, receiving the rotor and the stator therein, and provided at an outer peripheral portion thereof a tire;
a plurality of air guide protrusions formed in a circumference direction on outer and inner plates of the rim to allow air to be easily introduced;
a wheel speed sensor mounted on the stator to count a revolution number of the rotor;
a tire pressure sensor measuring an air pressure of the tire; and
a controller receiving sensor input values of a wheel, which are transmitted from a wheel speed sensor and a tire pressure sensor, through an Operation section and receives geographic and road information through a GPS receiver to control values of currents being supplied to the stator of each wheel.

2. The wheel of claim 1, further comprising:
a current controller controlling a rotation speed while changing current values of power being supplied to each stator under a control operation of the controller; and
overheat prevention sections transmitting a deceleration signal to the controller so that a speed of the wheel is reduced to prevent a driving unit including the rotor and the battery from being overheated based on a temperature value from a rotor temperature sensor, which is mounted on the rotor to measure a temperature of a wheel during driving of the wheel, and a temperature value of the battery obtained by a battery temperature sensor.

3. The wheel of claim 2, further comprising:
a current detector measuring remaining power of the battery being supplied to the stator to transmit a measurement result to the controller; and
a power generation controller automatically charging and supplying power while driving an alternator by using torque of a small power generator for a vehicle under the control operation of the controller if power of the battery is consumed according to a detection result of the current detector.

4. The wheel of claim 3, further comprising:
a cooling air supply section cooling the compressed air of a compressor together with air introduced through the air guide protrusions of the rim by supplying the compressed air to the rotor and the stator under the control operation of the controller if cooling is required based on temperature values from the overheat prevention section.

5. The wheel of claim 1, wherein both sides of the rim are coupled with an outer plate coupled with a bolt hole formed in the rotor through a bolt hole and an inner plate having a central portion coupled with the rotational shaft, and
wherein a bearing is fitted around an outer surface of the fixing shaft of the stator so that the rotational shaft, which is spaced apart from the fixing shaft while interposing the bearing between the fixing shaft and the rotational shaft, is smoothly rotated.

6. The wheel of claim 2, wherein both sides of the rim are coupled with an outer plate coupled with a bolt hole formed in the rotor through a bolt hole and an inner plate having a central portion coupled with the rotational shaft, and
wherein a bearing is fitted around an outer surface of the fixing shall of the stator so that the rotational shaft, which is spaced apart from the fixing shaft while interposing the bearing between the fixing shaft and the rotational shaft, is smoothly rotated.

7. The wheel of claim 3, wherein both sides of the rim are coupled with an outer plate coupled with a bolt hole formed in the rotor through a bolt hole, and an inner plate having a central portion coupled with the rotational shaft, and
wherein a bearing is fitted around an outer surface of the fixing shaft of the stator so that the rotational shaft, which is spaced apart from the fixing shaft while interposing the bearing between the fixing shaft and the rotational shaft, is smoothly rotated.

8. The wheel of claim 4, wherein both sides of the rim are coupled with an outer plate coupled with a bolt hole formed in the rotor through a bolt hole and an inner plate having a central portion coupled with the rotational shaft, and
wherein a bearing is fitted around an outer surface of the fixing shaft of the stator so that the rotational shaft, which is spaced apart from the fixing shaft while interposing the bearing between the fixing shaft and the rotational shaft, is smoothly rotated.
